(19) United States
(12) Patent Application Publication
(10) Pub. No.: US 2025/0294479 A1
(43) Pub. Date: Sep. 18, 2025

(54) ELECTRONIC DEVICE FOR CONTROLLING TRANSMISSION POWER AND METHOD FOR OPERATING SAME

(71) Applicant: Samsung Electronics Co., Ltd., Suwon-si (KR)

(72) Inventors: Hyoungkwon KIM, Suwon-si (KR); Dongho KIM, Suwon-si (KR); Sangwon KIM, Suwon-si (KR); Jinyoung SONG, Suwon-si (KR)

(21) Appl. No.: 19/070,928

(22) Filed: Mar. 5, 2025

Related U.S. Application Data
(63) Continuation of application No. PCT/KR2025/002839, filed on Feb. 28, 2025.

(30) Foreign Application Priority Data
Mar. 18, 2024 (KR) 10-2024-0036890
Apr. 15, 2024 (KR) 10-2024-0050160

(51) Int. Cl. H04W 52/36; H04W 52/28

(52) U.S. Cl. CPC H04W 52/367; H04W 52/288

(57) ABSTRACT

The disclosure relates to a device and a method for controlling the transmission power in an electronic device. The electronic device may include: a communication circuit, at least one processor, comprising processing circuitry, and a memory, wherein the memory stores instructions an at least one processor, individually and/or collectively, is configured to execute the instructions and to cause the electronic device to: configure a transmission power control variable, based on a TPC signal received from a network to which the electronic device is connected, based on a designated first update condition being satisfied while the electronic device is connected to the network, restrict an increase of the transmission power control variable based on a TPC signal indicating an increase of the transmission power control variable from the network, and transmit at least one signal with transmission power based on the transmission power control variable, the increase of which is restricted.

### CROSS-REFERENCE TO RELATED APPLICATIONS

This application is a continuation of International Application No. PCT/KR2025/002839 designating the United States, filed on Feb. 28, 2025, in the Korean Intellectual Property Receiving Office and claiming priority to Korean Patent Application Nos. 10-2024-0036890, filed on Mar. 18, 2024, and 10-2024-0050160, filed on Apr. 15, 2024, in the Korean Intellectual Property Office, the disclosures of each of which are incorporated by reference herein in their entireties.

### BACKGROUND

### Field

The disclosure relates to an electronic device for controlling transmission power and a method for operating the same.

### Description of Related Art

To meet the demand for wireless data traffic having increased since deployment of 4G communication systems, efforts have been made to develop a 5G communication system. Therefore, the 5G communication system is also called a “beyond 4G network” communication system or a “post LTE” system. The 5G communication system is considered to be implemented in 6 GHz or lower bands (e.g., about 3.5 GHz bands) or higher frequency bands (e.g., about 28 GHz bands or about 39 GHz bands), so as to accomplish higher data rates. To decrease propagation loss of the radio waves and increase the transmission distance of radio waves, beamforming, massive multiple-input multiple-output (massive MIMO), full dimensional MIMO (FD-MIMO), array antenna, analog beamforming, and large scale antenna techniques are under discussion in the 5G communication systems.

The above information may be presented as related art for the purpose of assisting in understanding the disclosure. No determination or assertion is made as to whether the foregoing might be asserted as prior art relevant to the disclosure or used for determination on prior art.

An electronic device (e.g., a user equipment (UE)) of a wireless communication system may dynamically configure transmission power, based on a power control signal (e.g., a transmission power control (TPC) command) received from a network device (e.g., an E-UTRAN node B (eNB) or a next generation node B (gNB)). For example, the electronic device may update (or configure) a transmission power control variable (e.g., TPC accumulation), based on a power control signal received from a network device. The electronic device may configure the transmission power to be used to transmit data to the network device, based on the updated transmission power control variable.

A continuous increase in a transmission power control variable based on a power control signal received from a network device, regardless of a channel state with the network, may cause the transmission power of an electronic device to be unnecessarily increased.

### SUMMARY

Embodiments of the disclosure provide a device and a method for controlling transmission power in an electronic device.

According to an example embodiment, an electronic device may include: a communication circuit, at least one processor, comprising processing circuitry, and memory storing instructions, wherein the instructions, when executed by at least one processor, individually and/or collectively, cause the electronic device to: configure a transmission power control variable, based on a transmission power control (TPC) signal received from a network, to which the electronic device is connected, via the communication circuit; based on a designated condition being satisfied while the electronic device is connected to the network, restrict an increase of the transmission power control variable based on a TPC signal indicating an increase of the transmission power control variable from the network; and transmit at least one signal with transmission power based on the transmission power control variable, the increase of which is restricted based on the TPC signal.

According to an example embodiment, a method for operating an electronic device may include: configuring a transmission power control variable, based on a TPC signal received from a network to which the electronic device is connected; based on a designated condition being satisfied while the electronic device is connected to the network, restricting an increase of the transmission power control variable based on the TPC signal indicating an increase of the transmission power control variable from the network; and transmitting at least one signal with transmission power based on the transmission power control variable, the increase of which is restricted based on the TPC signal.

According to an example embodiment, a non-transitory computer-readable storage medium (or a computer program product) for storing one or more programs may be described. According to an example embodiment, the one or more programs may include instructions which, when executed by at least one processor, comprising processing circuitry, of an electronic device, individually and/or collectively, cause the processor to perform operations comprising: configuring a transmission power control variable, based on a transmission power control (TPC) signal received from a network while being connected to the network, restricting an increase of the transmission power control variable based on the TPC signal indicating an increase of the transmission power control variable from the network based on a designated condition being satisfied while being connected to the network, and transmitting at least one signal with transmission power based on the transmission power control variable, the increase of which is restricted.

According to an example embodiment of the disclosure, when it is determined that transmission power (or a transmission power control variable) of an electronic device is unnecessarily increased, based on a channel state (and/or a channel change rate) with a network, the electronic device can selectively update the transmission power control variable, based on a power control signal received from the network, thereby mitigating the rate of increase in the unnecessary transmission power of the electronic device or reducing the unnecessary power consumption of the electronic device.

Various other effects understood directly or indirectly through the disclosure may be provided.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF THE DRAWINGS

With regard to the description of the drawings, the same or like reference signs may be used to designate the same or like elements. Further, the above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments;

FIG. 2 is a block diagram illustrating an example configuration of an electronic device for supporting 4G network communication and 5G network communication according to various embodiments;

FIG. 3 is a block diagram illustrating an example configuration of an electronic device for controlling transmission power according to various embodiments;

FIG. 4 is a flowchart illustrating example transmission power control in an electronic device according to various embodiments;

FIG. 5 is a flowchart illustrating example operations for identifying whether a designated first update condition associated with a transmission power control variable is satisfied, in an electronic device according to various embodiments;

FIG. 6 is a flowchart illustrating example operations for updating of a transmission power control variable while a designated first update condition associated with the transmission power control variable is satisfied, in an electronic device according to various embodiments.

FIG. 7 is a flowchart illustrating example operations for updating of a second transmission power control variable, based on a power control signal, in an electronic device according to various embodiments;

FIG. 8 is a flowchart illustrating example operations for updating of a second transmission power control variable, based on a first transmission power control variable, in an electronic device according to various embodiments;

FIG. 9 is a flowchart illustrating example operations for updating of a transmission power control variable while a designated third update condition associated with a transmission power control variable is satisfied, in an electronic device according to various embodiments; and

FIG. 10 is a flowchart illustrating example operations for updating of a second transmission power control variable while a designated third update condition associated with a transmission power control variable is satisfied, in an electronic device according to various embodiments.

### DETAILED DESCRIPTION

Hereinafter, various example embodiments will be described in greater detail with reference to the accompanying drawings.

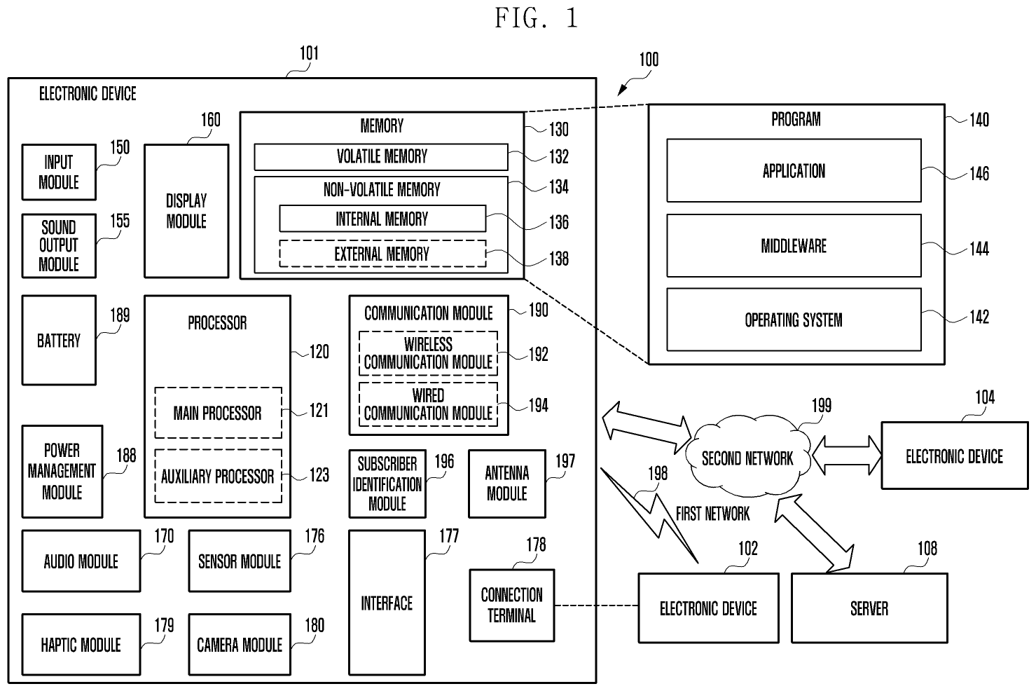

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls.

According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to an embodiment, the subscriber identification module 196 may include a plurality of subscriber identification modules. For example, the plurality of subscriber identification modules store different subscriber identification information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas include patch array antenna and/or dipole antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer.

The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

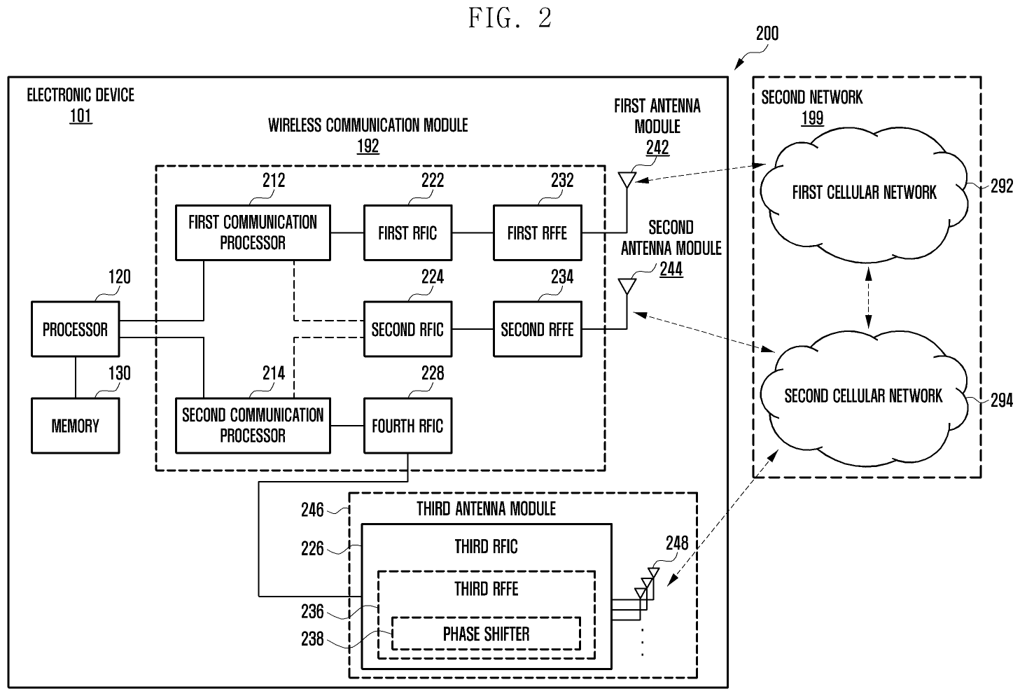

FIG. 2 is a block diagram 200 illustrating an example configuration of an electronic device 101 supporting 4G network communication and 5G network communication according to various embodiments.

Referring to FIG. 2, according to various embodiments, the electronic device 101 may include a first communication processor (e.g., including processing circuitry) 212, a second communication processor (e.g., including processing circuitry) 214, a first radio frequency integrated circuit (RFIC) 222, a second RFIC 224, a third RFIC 226, a fourth RFIC 228, a first radio frequency front end (RFFE) 232, a second RFFE 234, a first antenna module (e.g., including an antenna) 242, a second antenna module (e.g., including an antenna) 244, and an antenna 248. The electronic device 101 may include the processor (e.g., including processing circuitry) 120 and the memory 130. The network 199 may include a first network 292 and a second network 294. According to an embodiment, the electronic device 101 may further include at least one component among the components illustrated in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may be at least a part of the wireless communication module 192. According to an embodiment, the fourth RFIC 228 may be omitted, or may be included as a part of the third RFIC 226.

The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The first communication processor 212 may establish a communication channel of a band to be used for wireless communication with the first network 292, and may support legacy network communication (e.g., 4G network communication) via the established communication channel. According to an embodiment, the first network 292 may be a legacy network including second generation (2G), third generation (3G), fourth generation (4G), or long-term evolution (LTE) network. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The second communication processor 214 may establish a communication channel corresponding to a designated band (e.g., approximately 6 GHz to 60 GHZ) among bands to be used for wireless communication with the second network 294, and may support 5G network communication via the established communication channel. According to an embodiment, the second network 294 may be a 5G network (e.g., new radio (NR)) defined in 3GPP. In addition, according to an embodiment, the first communication processor 212 or the second communication processor 214 may establish a communication channel corresponding to another designated band (e.g., approximately 6 GHz or less) among bands to be used for wireless communication with the second network 294, and may support 5G network communication via the established communication channel. According to an embodiment, the first communication processor 212 and the second communication processor 214 may be implemented in a single chip or a single package. According to an embodiment, the first communication processor 212 or the second communication processor 214 may be implemented in a single chip or a single package, together with the processor 120, the auxiliary processor 123, or the communication module 190.

According to an embodiment, the first communication processor 212 may perform data transmission or reception with the second communication processor 214. For example, data which has been classified to be transmitted via the second network 294 may be changed to be transmitted via the first network 292.

In this instance, the first communication processor 212 may receive transmission data from the second communication processor 214. For example, the first communication processor 212 may perform data transmission or reception with the second communication processor 214 via an inter-processor interface. The inter-processor interface may be implemented as, for example, a universal asynchronous receiver/transmitter (UART) (e.g., a high speed-UART (HS-UART)) or a peripheral component interconnect bus express (PCIe), but the type of interface is not limited thereto. For example, the first communication processor 212 and the second communication processor 214 may exchange control information and packet data information using, for example, a shared memory. For example, the first communication processor 212 may perform transmission or reception of various types of information such as sensing information, information associated with an output strength, and resource block (RB) allocation information, with the second communication processor 214.

Depending on implementation, the first communication processor 212 may not be directly connected to the second communication processor 214. In this instance, the first communication processor 212 may perform data transmission or reception with the second communication processor 214, via the processor 120 (e.g., an application processor). For example, the first communication processor 212 and the second communication processor 214 may perform data transmission or reception via the processor 120 (e.g., an application processor) and a HS-UART interface or a PCIe interface, but the type of interface is not limited. For example, the first communication processor 212 and the second communication processor 214 may exchange control information and packet data information using the processor 120 (e.g., an application processor) and a shared memory. According to an embodiment, the first communication processor 212 and the second communication processor 214 may be implemented in a single chip or a single package. According to various embodiments, the first communication processor 212 or the second communication processor 214 may be implemented in a single chip or a single package, together with the processor 120, the auxiliary processor 123, or the communication module 190.

In the case of transmission, the first RFIC 222 may convert a baseband signal generated by the first communication processor 212 into a radio frequency (RF) signal in the range of approximately 700 MHz to 3 GHZ, which is used in the first network 292 (e.g., a legacy network). In the case of reception, an RF signal is obtained from the first network 292 (e.g., a legacy network) via an antenna (e.g., the first antenna module 242), and may be preprocessed via an RFFE (e.g., the first RFFE 232). The first RFIC 222 may convert the preprocessed RF signal into a baseband signal so that the baseband signal is processed by the first communication processor 212.

In the case of transmission, the second RFIC 224 may convert a baseband signal generated by the first communication processor 212 or the second communication processor 214 into an RF signal (hereinafter, a 5G Sub6 RF signal) in an Sub6 band (e.g., approximately 6 GHz or less) used in the second network 294 (e.g., a 5G network). In the case of reception, a 5G Sub6 RF signal may be obtained from the second network 294 (e.g., a 5G network) via an antenna (e.g., the second antenna module 244), and may be preprocessed by an RFFE (e.g., the second RFFE 234). The second RFIC 224 may convert the preprocessed 5G Sub6 RF signal into a baseband signal so that the signal may be processed by a corresponding communication processor among the first communication processor 212 or the second communication processor 214.

The third RFIC 226 may convert a baseband signal generated by the second communication processor 214 into an RF signal (hereinafter, a 5G Above6 RF signal) of a 5G Above6 band (e.g., approximately 6 GHz to 60 GHz) to be used in the second network 294 (e.g., a 5G network). In the case of reception, a 5G Above6 RF signal is obtained from the second network 294 (e.g., a 5G network) via an antenna (e.g., the antenna 248), and may be preprocessed by the third RFFE 236. The third RFIC 226 may convert the preprocessed 5G Above6 RF signal into a baseband signal so that the signal is processed by the second communication processor 214. According to an embodiment, the third RFFE 236 may be implemented as a part of the third RFIC 226.

According to an embodiment, the electronic device 101 may include the fourth RFIC 228, separately from or, as a part of, the third RFIC 226. In this instance, the fourth RFIC 228 may convert a baseband signal produced by the second communication processor 214 into an RF signal (hereinafter, an IF signal) in an intermediate frequency band (e.g., approximately 9 GHz to 11 GHZ), and may transfer the IF signal to the third RFIC 226. The third RFIC 226 may convert the IF signal into a 5G Above6 RF signal. In the case of reception, a 5G Above6 RF signal may be received from the second network 294 (e.g., a 5G network) via an antenna (e.g., the antenna 248), and may be converted into an IF signal by the third RFIC 226. The fourth RFIC 228 may convert the IF signal into a baseband signal so that the second communication processor 214 is capable of processing the baseband signal.

According to an embodiment, the first RFIC 222 and the second RFIC 224 may be implemented as at least a part of a single chip or a single package. According to an embodiment, the first RFFE 232 and the second RFFE 234 may be implemented as at least a part of a single chip or single package. According to an embodiment, at least one of the first antenna module 242 or the second antenna module 244 may be omitted or may be combined with another antenna module, to process RF signals of a plurality of corresponding bands.

According to an embodiment, the third RFIC 226 and the antenna 248 may be disposed in the same substrate, and may form a third antenna module 246. For example, the wireless communication module 192 or the processor 120 may be disposed in a first substrate (e.g., a main PCB). In this instance, the third RFIC 226 is disposed in a part (e.g., a lower part) of a second substrate (e.g., a sub PCB) different from the first substrate, and the antenna 248 is disposed in another part (e.g., an upper part), so that the third antenna module 246 may be formed. By disposing the third RFIC 226 and the antenna 248 in the same substrate, the length of a transmission line therebetween may be reduced. For example, this may reduce a loss (e.g., a diminution) of a high-frequency band signal (e.g., approximately 6 GHz to 60 GHz) used for 5G network communication, the loss being caused by a transmission line. Accordingly, the electronic device 101 may improve the quality or speed of communication with the second network 294 (e.g., a 5G network).

According to an embodiment, the antenna 248 may be implemented as an antenna array including a plurality of antenna elements which may be used for beamforming. In this instance, the third RFIC 226, for example, may include a plurality of phase shifters 238 corresponding to a plurality of antenna elements, as a part of the third RFFE 236. In the case of transmission, each of the plurality of phase shifters 238 may shift the phase of a 5G Above6RF signal to be transmitted to the outside of the electronic device 101 (e.g., a base station of a 5G network) via a corresponding antenna element. In the case of reception, each of the plurality of phase shifters 238 may shift the phase of a 5G Above6 RF signal received from the outside via a corresponding antenna element into the same or substantially the same phase. This may enable transmission or reception via beamforming between the electronic device 101 and the outside.

The second network 294 (e.g., a 5G network) may operate independently (e.g., Standalone (SA)) from the first network 292 (e.g., a legacy network), or may operate by being connected thereto (e.g., Non-Standalone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access the access network of the 5G network, and may access an external network (e.g., the Internet) under the control of the core network (e.g., an evolved packed core (EPC)) of the legacy network. Protocol information (e.g., LTE protocol information) for communication with the legacy network or protocol information (e.g., new radio (NR) protocol information) for communication with the 5G network may be stored in the memory 130, and may be accessed by another component (e.g., the processor 120, the first communication processor 212, or the second communication processor 214).

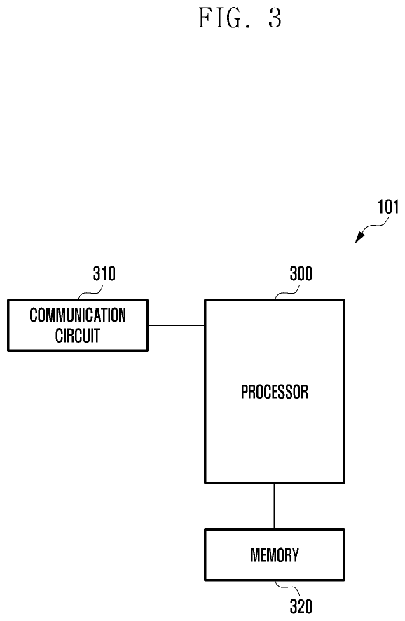

FIG. 3 is a block diagram illustrating an example configuration of an electronic device for controlling transmission power according to various embodiments. For example, an electronic device 101 of FIG. 3 may be at least partially similar to the electronic device 101 of FIG. 1 or FIG. 2, or may further include various embodiments of the electronic device.

According to an embodiment with reference to FIG. 3, the electronic device 101 may include at least one of a processor (e.g., including processing circuitry) 300, a communication circuit (or communication circuitry) 310, and/or a memory 320. According to an embodiment, the processor 300 may be substantially the same as, or included in, the processor 120 (e.g., a communication processor) of FIGS. 1 and/or 2 and the description thereof applies equally here and may not be repeated. The communication circuit 310 may be substantially the same as, or included in, the wireless communication module 192 of FIG. 1 or 2. The memory 320 may be substantially the same as, or included in, the memory 130 of FIG. 1 or 2. For example, the processor 300 may be operatively, functionally, and/or electrically connected to at least one of the communication circuit 310 or the memory 320. For example, the processor 300 may include at least one processor including a processing circuit.

According to an embodiment, the processor 300 may include various processing circuitry and configure the transmission power of the electronic device 101, based on a power control signal received from a network, when the processor is connected to the network. For example, the processor 300 may configure (or update) a transmission power control variable (e.g., a transmission power control variable or a transmission power control parameter), based on the power control signal received from the network. The processor 300 may configure (or update) the transmission power of the electronic device 101, based on the transmission power control variable. In an example, the transmission power control variable may include an accumulation value of variables (or values) (e.g., −1, 0, 1, or 3) for controlling the transmission power included in the power control signal. In an example, the transmission power control variable may be decreased, maintained, or increased based on a variable for controlling the transmission power included in the power control signal. In an example, the power control signal is a transmission power control (TPC) command and may be received (or acquired) by being included in a downlink control indicator (DCI) of a designated format.

According to an embodiment, the processor 300 may continuously or periodically identify at least one of a channel state or a channel change rate with a network while being connected to the network. For example, the channel state may include the channel state of a downlink (DL) and/or an uplink (UL). For example, the channel state may include at least one of received signal strength indication (RSSI), reference signal received quality (RSRQ), reference signal received power (RSRP), a signal to noise ratio (SNR), a signal to interference and noise ratio (SINR), a quality of service (QOS), a block error rate (BLER), a retransmission rate, or a bit error rate (BER). For example, the state of being connected to a network may include a radio resource control (RRC) connected state.

According to an embodiment, the processor 300 may identify whether a designated first update condition associated with the transmission power control variable is satisfied while being connected to a network. For example, the processor 300 may identify whether the designated first update condition associated with the transmission power control variable is satisfied, based on at least one of a channel state with a network, a channel change rate with a network, or a power mode configuration variable. For example, the processor 300 may determine that the designated first update condition associated with the transmission power control variable is satisfied in case that the channel state with the network satisfies a designated channel state condition, the channel change rate with the network satisfies a designated channel change condition, and the power mode configuration variable exceeds a designated first reference value. In an example, the channel change rate may include variance of the channel states with the network measured periodically or continuously during a designated first time period. In an example, the power mode configuration variable may include an accumulation value (or sum) of variables for controlling transmission power included in a designated number of signals for increasing or decreasing transmission power (or a transmission power control variable) received at a timepoint prior to the current timepoint among power control signals (e.g., TPCs) received from the network. For example, a state satisfying a designated channel state condition may include a state (e.g., medium electric field and/or strong electric field) in which the channel state with the network has a value (e.g., electric field value) equal to or greater than that of a designated reference channel state. For example, a state satisfying a designated channel change condition may include a state in which a channel change rate with the network is lower than a designated reference change rate.

For example, the processor 300 may determine that a designated first update condition associated with the transmission power control variable is not satisfied in case that the channel state with the network does not satisfy a designated channel state condition, the channel change rate with the network does not satisfy a designated channel change condition, or the power mode configuration variable is equal to or smaller than a designated first reference value. In an example, a state that does not satisfy the designated channel state condition may include a state (e.g., weak electric field and/or medium electric field) in which the channel state with the network has a value (e.g., electric field value) smaller than that of a designated reference channel state. For example, a state that does not satisfy the designated channel change condition may include a state in which the channel change rate with the network is equal to or greater than a designated reference change rate.

According to an embodiment, when it is determined that a designated first update condition associated with the transmission power control variable is satisfied, the processor 300 may selectively update the transmission power control variable, based on the power control signal received from the network. For example, the selective updating of the transmission power control variable may include a state in which the transmission power control variable is decreased or maintained based on a variable (e.g., −1 or 0) for controlling the transmission power included in the power control signal, but the increase of which is restricted based on a variable (e.g., 1 or 3) for controlling the transmission power included in the power control signal.

For example, when it is determined that the designated first update condition associated with the transmission power control variable is satisfied, the processor 300 may generate a second transmission power control variable that operates independently of the first transmission power control variable. In an example, the second transmission power control variable may include the same value as the first transmission power control variable as its initial value. For example, the first transmission power control variable may represent a transmission power control variable for controlling the transmission power of the electronic device 101 prior to a situation in which a designated first update condition associated with the transmission power control variable is satisfied. In an example, the second transmission power control variable may represent a transmission power control variable for controlling the transmission power of the electronic device 101 after a situation in which a designated first update condition associated with the transmission power control variable is satisfied.

For example, in the case of receiving the power control signal from the network via the communication circuit 310, the processor 300 may update the first transmission power control variable and/or the second transmission power control variable, based on the power control signal. In an example, the first transmission power control variable may be decreased, maintained, or increased based on a variable (e.g., −1, 0, 1, or 3) for controlling the transmission power included in the power control signal. In an example, in case that a designated first update condition associated with the transmission power control variable is satisfied, the second transmission power control variable may be decreased or maintained based on a variable (e.g., −1, 0, 1, or 3) for controlling the transmission power included in the power control signal, and the increase of which may be restricted based on a variable (e.g., −1, 0, 1, or 3) for controlling the transmission power included in the power control signal.

For example, in case that the second transmission power control variable updated (e.g., maintained or decreased) based on the power control signal is smaller than a reference transmission power control variable, the processor 300 may additionally update the second transmission power control variable, based on the reference transmission power control variable. In an example, the second transmission power control variable may additionally be updated to the same value as the reference transmission power control variable. For example, the reference transmission power control variable may include an average value of the first transmission power control variables that have been identified for a designated second time period prior to a timepoint at which the designated first update condition associated with the transmission power control variable is determined as having been satisfied.

For example, when it is determined that a difference value between the first transmission power control variable and the second transmission power control variable, which has been updated based on the power control signal and/or the reference transmission power control variable, satisfies a designated second update condition associated with the transmission power control variable, the processor 300 may additionally update the second transmission power control variable, based on the first transmission power control variable and a designated third reference value. In an example, a state satisfying the designated second update condition associated with the transmission power control variable may include a state in which a difference value between the first transmission power control variable and the second transmission power control variable, which has been updated based on the power control signal and/or the reference transmission power control variable, exceeds a designated third reference value. In an example, the second transmission power control variable may additionally be updated (or configured) based on a difference value between the first transmission power control variable and the designated third reference value.

According to an embodiment, the processor 300 may configure (or update) the transmission power of the electronic device 101, based on the second transmission power control variable. The processor 300 may control the communication circuit 310 to transmit at least one signal (or data) with the transmission power configured (or updated) based on the second transmission power control variable.

According to an embodiment, the processor 300 may identify whether a designated third update condition associated with a transmission power control variable is satisfied while the designated first update condition associated with the transmission power control variable is satisfied. For example, the processor 300 may determine that the designated third update condition associated with the transmission power control variable is satisfied in case that the channel state with the network does not satisfy the designated channel condition, the channel change rate with the network does not satisfy the designated channel change condition, or the power mode configuration variable exceeds the designated second reference value while the designated first update condition associated with the transmission power control variable is satisfied. For example, a state that does not satisfy the designated channel state condition may include a state (e.g., weak electric field and/or medium field) in which the channel state with the network has a value (e.g., electric field value) smaller than that of the designated reference channel state. For example, a state that does not satisfy the designated channel change condition may include a state in which the channel change rate with the network is equal to or greater than a designated reference change rate.

For example, the processor 300 may determine that the designated third update condition associated with the transmission power control variable is not satisfied in case that the channel state with the network satisfies the designated channel state condition, the channel change rate with the network satisfies the designated channel change condition, and the transmission mode configuration variable is equal to or smaller than a designated second reference value. In an example, a state satisfying the designated channel state condition may include a state (e.g., medium electric field and/or strong electric field) in which the channel state with the network has a value (e.g., electric field value) equal to or greater than that of a designated reference channel state. In an example, a state satisfying the designated channel change condition may include a state in which the channel change rate with the network is lower than a designated reference change rate.

According to an embodiment, when it is determined that the designated third update condition associated with the transmission power control variable is satisfied, the processor 300 may update a transmission power control variable (e.g., a second transmission power control variable), based on a power control signal received from the network. For example, in case that a second transmission power control variable corresponding to a first transmission power control variable is generated based on that the designated first update condition associated with the transmission power control variable is satisfied, the processor 300 may update the first transmission power control variable and the second transmission power control variable, based on the power control signal received from the network via the communication circuit 310. For example, the first transmission power control variable may be decreased, maintained, or increased based on a variable (e.g., −1, 0, 1, or 3) for controlling transmission power included in the power control signal.

For example, in case that the second transmission power control variable updated (e.g., decreased) based on the power control signal is smaller than the minimum transmission power control variable, the processor 300 may additionally update the second transmission power control variable, based on the minimum transmission power control variable. In an example, the second transmission power control variable may additionally be updated to the same value as the minimum transmission power control variable. For example, the minimum transmission power control variable may include a minimum value of the transmission power control variable enabling the electronic device 101 to maintain a connection with the network.

According to an embodiment, the processor 300 may configure (or update) the transmission power of the electronic device 101, based on the second transmission power control variable. The processor 300 may control the communication circuit 310 to transmit at least one signal (or data) with the transmission power configured (or updated) based on the second transmission power control variable.

According to an embodiment, when it is determined that a designated first update condition associated with the transmission power control variable is satisfied while a designated third update condition associated with the transmission power control variable is satisfied, the processor 300 may selectively update the transmission power control variable, based on a power control signal received from the network.

According to an embodiment, when there is a history of determining that the designated first update condition associated with the transmission power control variable is satisfied while a connection to the network is maintained, the processor 300 may configure (or update) the transmission power of the electronic device 101, based on the second transmission power control variable, until the connection between the electronic device 101 and the network is released. For example, the processor 300 may stop (or restrict) the use of the second transmission power control variable when a configuration of a physical uplink shared channel (PUSCH) by the network is changed. For example, the processor 300 may stop (or restrict) the use of the second transmission power control variable when a serving network changes. For example, the processor 300 may stop (or restrict) the use of the second transmission power control variable when an RRC state with the network is switched to an RRC inactive state or an RRC idle state. For example, when it is determined to stop (or restrict) the use of the second transmission power control variable, the processor 300 may configure (or update) the transmission power of the electronic device 101, using the first transmission power control variable, based on the connection to the network. For example, the first transmission power control variable may include a transmission power control variable generated based on the connection to the network.

According to an embodiment, the processor 300 may dynamically configure the reference values associated with the designated first update condition associated with the transmission power control variable and/or the designated third update condition associated with the transmission power control variable. For example, the reference values associated with the designated first update condition associated with the transmission power control variable and/or the designated third update condition associated with the transmission power control variable may be dynamically configured based on the channel state with the network (e.g., strong electric field or medium electric field), as shown in Table 1 below.

TABLE 1

| Channel state | N | N1 | N2 | N3 |
|---|---|---|---|---|
| high (strong electric field) | 10 | 5 | 2 | 20 |
| (SINR > 20 dB & ulBLER < 10%) | | | | |
| Mid (medium electric field) | 20 | 10 | 5 | 10 |
| (SINR > 5 dB & ulBLER < 20%) | | | | |

For example, N represents the designated number for configuring a power mode configuration variable, N1 represents a designated first reference value for determining a designated first update condition associated with a transmission power control variable, and N2 may represent a designated second reference value for determining a designated third update condition associated with a transmission power control variable, and N3 may represent a designated third reference value for determining whether to additionally update a second transmission power control variable, based on a difference value between the first transmission power control variable and the second transmission power control variable.

According to an embodiment, the communication circuit 310 may support wireless communication of the electronic device 101 and an external electronic device (e.g., the electronic device 102 or 104 of FIG. 1). For example, the communication circuit 310 may include an RFIC (e.g., the first RFIC 222, the second RFIC 224, the third RFIC 226, and/or the fourth RFIC 228 of FIG. 2), and an RFFE (e.g., the first RFFE 232, the second RFFE 234, the third RFFE 236, and/or the fourth RFFE 238 of FIG. 2) that process signals or data that are transmitted or received via radio resources. For example, wireless communications may include cellular communications (e.g., long term evolution (LTE) and/or new radio (NR)).

According to an embodiment, the memory 320 may store various data used by at least one element (e.g., the processor 300 or the communication circuit 310) of the electronic device 101. For example, the memory 320 may store various instructions that may be executed by the processor 300. In an embodiment, instructions may be executed individually or collectively by the processor 300 (e.g., at least one processor).

In an embodiment, in case that the update of the second transmission power control variable is not performed based on the designated third reference value in a state in which the designated first update condition associated with the transmission power control variable is satisfied, the electronic device 101 may update the second transmission power control variable, based on the designated third reference value in a state in which the designated third update condition associated with the transmission power control variable is satisfied. For example, in case that a difference value between the second transmission power control variable updated based on the power control signal and the first transmission power control variable exceeds a designated third reference value in a state in which a designated third update condition associated with the transmission power control variable is satisfied, the processor 300 may update the second transmission power control variable based on the first transmission power control variable and the designated third reference value. For example, the second transmission power control variable may be updated (or configured) based on a difference value between the first transmission power control variable and the designated third reference value.

According to an example embodiment, an electronic device (e.g., the electronic device 101 of FIG. 1, FIG. 2, or FIG. 3) may include: a communication circuit (e.g., the wireless communication module 192 of FIG. 1 or FIG. 2, or the communication circuit 310 of FIG. 3), at least one processor, comprising processing circuitry (e.g., the processor 120 of FIG. 1 or FIG. 2, or the processor 300 of FIG. 3), and memory (e.g., the memory 130 of FIG. 1 or FIG. 2, or the memory 320 of FIG. 3) storing instructions. According to an example embodiment, the instructions, when executed by at least one processor, individually and/or collectively, cause the electronic device to configure a transmission power control variable (e.g., a first transmission power control variable), based on a transmission power control (TPC) signal (e.g., a power control signal) received from a network, to which the electronic device is connected, via the communication circuit; based on a designated first update condition being satisfied in a state of being connected to the network, restrict an increase of the transmission power control variable based on a TPC signal indicating an increase of the transmission power control variable from the network; and transmit at least one signal with transmission power based on the transmission power control variable (e.g., a second transmission power control variable), the increase of which is restricted based on the TPC signal.

According to an example embodiment, the memory storing instructions, when executed by at least one processor individually or collectively, cause the electronic device to, based on a designated first update condition being satisfied while being connected to a network, configure a second transmission power control variable corresponding to the first transmission power control variable configured based on the TPC signal received from the network, wherein the increase of the second transmission power control variable may be restricted based on the TPC signal while the designated first update condition is satisfied.

According to an example embodiment, the memory storing instructions, when executed by at least one processor individually or collectively, cause the electronic device to identify whether a designated first update condition is satisfied, based on at least one of a channel state with the network, a channel rate change with the network, or a power mode configuration variable while being connected to the network.

According to an example embodiment, the power mode configuration variable may include an accumulation value of a designated number of TPC signals indicating an increase or decrease of the first transmission power control variable.

According to an example embodiment, the memory storing instructions, when executed by at least one processor individually or collectively, cause the electronic device to, based on a designated first update condition being satisfied, configure the reference transmission power control variable based on an average value of the first transmission power control variables configured based on a designated number of TPC signals; and based on the second transmission power control variable decreased based on the TPC signal being less than the reference transmission power control variable, update the second transmission power control variable based on the reference transmission power control variable.

According to an example embodiment, the memory storing instructions, when executed by at least one processor individually or collectively, cause the electronic device to, based on the TPC signal received from the network including a variable associated with decreasing the transmission power of the electronic device, decrease the second transmission power control variable by a designated magnitude; and based on the TPC signal received from the network including a variable associated with maintaining or increasing the transmission power of the electronic device, restrict update of the second transmission power control variable.

According to an example embodiment, the memory storing instructions, when executed by at least one processor individually or collectively, cause the electronic device to, based on the second transmission power control variable being selectively updated based on the TPC signal, increase, maintain, or decrease the first transmission power control variable, based on the TPC signal.

According to an example embodiment, the memory storing instructions, when executed by at least one processor individually or collectively, cause the electronic device to, based on a difference value between the first transmission power control variable and the second transmission power control variable satisfying a designated second update condition, update the second transmission power control variable, based on the first transmission power control variable.

According to an example embodiment, the memory storing instructions, when executed by at least one processor individually or collectively, cause the electronic device to, based on a third update condition different from the designated first update condition being satisfied while the designated first update condition is determined to be satisfied, configure the transmission power control variable based on a TPC signal received from the network, wherein the transmission power control variable may be increased, maintained, or decreased based on the TPC signal while the designated third update condition is satisfied.

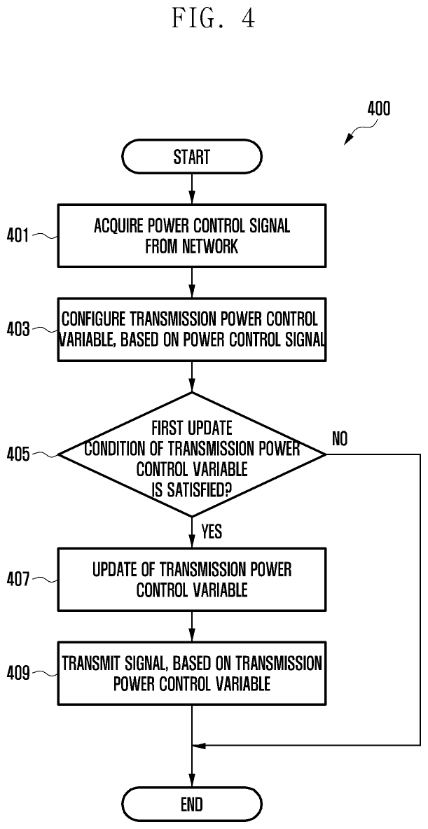

FIG. 4 is a flowchart 400 illustrating example operations for transmission power control in an electronic device according to various embodiments. In the various embodiments below, each operation may be performed sequentially, but is not necessarily performed sequentially. For example, the order of each operation may be changed, and at least two operations may be performed in parallel. In an example, the electronic device of FIG. 4 may be the electronic device 101 of FIG. 1, 2 or 3.

According to an embodiment with reference to FIG. 4, an electronic device (e.g., the electronic device 101) or a processor (e.g., the processor 120 of FIG. 1 or FIG. 2 or the processor 300 of FIG. 3) may acquire a power control signal from a network to which the electronic device 101 is connected, in operation 401. For example, the power control signal may be a transmission power control (TPC) command, which may be received (or acquired) by being included in a downlink control indicator (DCI) of a designated format.

According to an embodiment, an electronic device (e.g., the electronic device 101) or a processor (e.g., the processor 120 or 300) may configure (or update) a transmission power control variable based on a power control signal acquired from the network, in operation 403. For example, the transmission power control variable may include an accumulation value of variables (e.g., −1, 0, 1, or 3) for controlling the transmission power included in the power control signal. In an example, the transmission power control variable may be decreased, maintained, or increased, based on a variable for controlling the transmission power included in the power control signal. For example, when there is at least one signal (or data) to be transmitted to a network (or a network device), the processor 300 may control the communication circuit 310 to transmit at least one signal (or data) to the network (or the network device) with the transmission power configured (or updated) based on the transmission power control variable.

According to an embodiment, an electronic device (e.g., the electronic device 101) or a processor (e.g., the processor 120 or 300) may identify whether a designated first update condition associated with a transmission power control variable is satisfied while being connected to a network, in operation 405. For example, the processor 300 may continuously or periodically identify at least one of a channel state or a channel change rate with the network while being connected to the network. In an example, the channel state may include a channel state of a downlink (DL) and/or an uplink (UL). For example, the channel state may include at least one of received signal strength indication (RSSI), reference signal received quality (RSRQ), reference signal received power (RSRP), a signal to noise ratio (SNR), a signal to interference and noise ratio (SINR), a quality of service (QOS), a block error rate (BLER), a retransmission rate, or a bit error rate (BER). For example, the state of being connected to the network may include a radio resource control (RRC) connected state.

For example, the processor 300 may identify whether the designated first update condition associated with the transmission power control variable is satisfied, based on at least one of the channel state with the network, the channel change rate with the network, or the power mode configuration variable.

For example, in case that the channel state with the network satisfies a designated channel state condition, the channel change rate with the network satisfies a designated channel change condition, and the power mode configuration variable exceeds a designated first reference value, the processor 300 may determine that the designated first update condition associated with the transmission power control variable is satisfied. In an example, the channel change rate may include the variance of the channel state with the network measured periodically or continuously during a designated first time period. In an example, the power mode configuration variable may include an accumulation value (or sum) of variables for controlling transmission power included in a designated number of signals for increasing or decreasing transmission power received at a timepoint prior to the current timepoint among power control signals received from the network. In an example, a state satisfying a designated channel state condition may include a state (e.g., medium electric field and/or strong electric field) in which the channel state with the network has a value (e.g., electric field value) equal to or greater than that of a designated reference channel state. For example, a state satisfying a designated channel change condition may include a state in which a channel change rate with the network is lower than a designated reference change rate.

For example, the processor 300 may determine that a designated first update condition associated with the transmission power control variable is not satisfied in case that the channel state with the network does not satisfy a designated channel state condition, the channel change rate with the network does not satisfy a designated channel change condition, or the power mode configuration variable is equal to or smaller than a designated first reference value. In an example, a state that does not satisfy the designated channel state condition may include a state (e.g., weak electric field and/or medium electric field) in which the channel state with the network has a value (e.g., electric field value) smaller than that of a designated reference channel state. In an example, a state that does not satisfy the designated channel change condition may include a state in which the channel change rate with the network is equal to or greater than a designated reference change rate.

According to an embodiment, when it is determined that a designated first update condition associated with the transmission power control variable is satisfied (e.g., “yes” in operation 405), an electronic device (e.g., the electronic device 101) or a processor (e.g., the processor 120 or 300) may selectively update the transmission power control variable to be used to configure the transmission power of the electronic device 101, based on the power control signal received from the network, in operation 407. For example, the selective update of the transmission power control variable may include a state in which the transmission power control variable is decreased or maintained based on a variable (e.g., −1 or 0) for controlling the transmission power included in the power control signal, but the increase of which is restricted based on a variable (e.g., 1 or 3) for controlling the transmission power included in the power control signal.

For example, when it is determined that the designated first update condition associated with the transmission power control variable is satisfied, the processor 300 may generate a second transmission power control variable that operates independently of the first transmission power control variable. In an example, the second transmission power control variable may include the same value as the first transmission power control variable as its initial value. In an example, the first transmission power control variable may represent a transmission power control variable for controlling the transmission power of the electronic device 101 prior to a situation in which a designated first update condition associated with the transmission power control variable is satisfied. In an example, the second transmission power control variable may represent a transmission power control variable for controlling the transmission power of the electronic device 101 after a situation in which a designated first update condition associated with the transmission power control variable is satisfied.

For example, in the case of receiving the power control signal from the network via the communication circuit 310, the processor 300 may update the first transmission power control variable and/or the second transmission power control variable, based on the power control signal. In an example, the first transmission power control variable may be decreased, maintained, or increased based on a variable (e.g., −1, 0, 1, or 3) for controlling the transmission power included in the power control signal. In an example, in case that a designated first update condition associated with the transmission power control variable is satisfied, the second transmission power control variable may be decreased or maintained based on a variable (e.g., −1, 0, 1, or 3) for controlling the transmission power included in the power control signal, and the increase of which may be restricted based on a variable (e.g., −1, 0, 1, or 3) for controlling the transmission power included in the power control signal.

For example, in case that the second transmission power control variable updated (e.g., maintained or decreased) based on the power control signal is smaller than a reference transmission power control variable, the processor 300 may additionally update the second transmission power control variable, based on the reference transmission power control variable. In an example, the second transmission power control variable may additionally be updated to the same value as the reference transmission power control variable. For example, the reference transmission power control variable may include an average value of the first transmission power control variables that have been identified for a designated second time period prior to a timepoint at which the designated first update condition associated with the transmission power control variable is determined as having been satisfied.

For example, in case that a difference value between the first transmission power control variable which has been updated based on the power control signal and the second transmission power control variable which has been updated based on the power control signal and/or the reference transmission power control variable is determined to satisfy the designated second update condition associated with the transmission power control variable, the processor 300 may additionally update the second transmission power control variable, based on the first transmission power control variable and a designated third reference value. In an example, a state satisfying the designated second update condition associated with the transmission power control variable may include a state in which a difference value between the first transmission power control variable and the second transmission power control variable, which has been updated based on the power control signal and/or the reference transmission power control variable, exceeds a designated third reference value. In an example, the second transmission power control variable may additionally be updated (or configured) based on a difference value between the first transmission power control variable and a designated third reference value.

According to an embodiment, an electronic device (e.g., the electronic device 101) or a processor (e.g., the processor 120 or 300) may transmit at least one signal (or data) to a network (or a network device), based on a transmission power control variable (e.g., a second transmission power control variable) that is selectively updated based on a power control signal obtained from the network, in operation 409. For example, the processor 300 may configure (or update) the transmission power of the electronic device 101, based on a second transmission power control variable that is selectively updated based on a power control signal obtained from the network. The processor 300 may control the communication circuit 310 to transmit at least one signal (or data) to the network (or the network device) with the transmission power configured (or updated) based on the second transmission power control variable.

According to an embodiment, when it is determined that the designated first update condition associated with the transmission power control variable is not satisfied (e.g., “no” in operation 405), an electronic device (e.g., the electronic device 101) or a processor (e.g., the processor 120 or 300) may end controlling the transmission power. For example, when it is determined that the designated first update condition associated with the transmission power control variable is not satisfied, the processor 300 may configure (or update) the transmission power of the electronic device 101, based on the transmission power control variable (e.g., the first transmission power control variable) that is configured (or updated) based on the power control signal.

According to an embodiment, the electronic device 101 may, based on the channel state with the network, dynamically configure reference values associated with the designated first update condition associated with the transmission power control variable. For example, the reference values associated with the designated first update condition associated with the transmission power control variable may include at least one of a designated number of signals for configuring the power mode configuration variable, a designated first reference value for determining the designated first update condition associated with the transmission power control variable, or a designated third reference value for determining whether to update the second transmission power control variable.

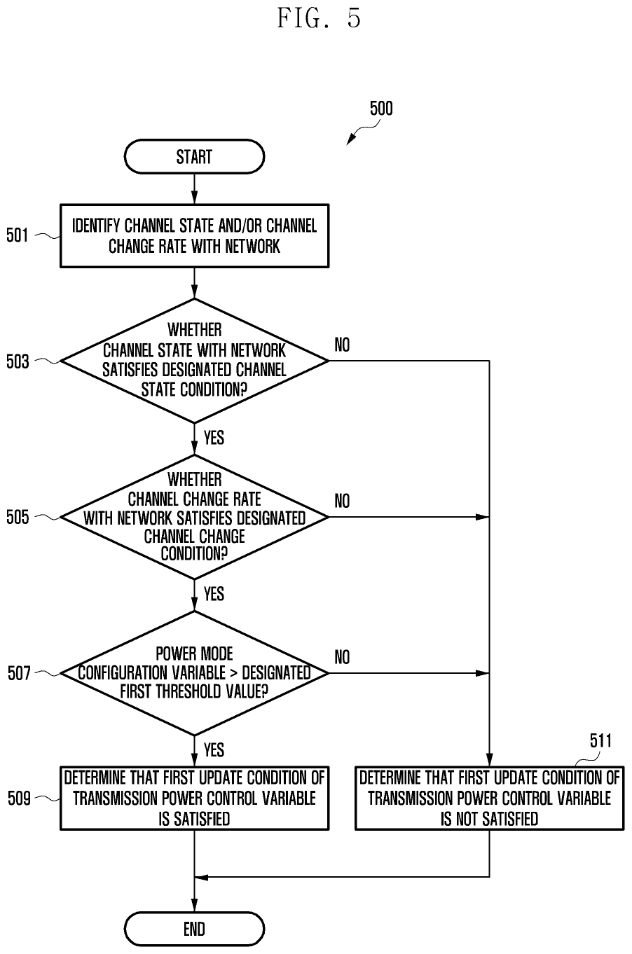

FIG. 5 is a flowchart 500 illustrating example operations for identifying whether a designated first update condition associated with a transmission power control variable is satisfied, in an electronic device according to various embodiments. In an example, at least a portion of operations of FIG. 5 may include the detailed operation of operation 405 of FIG. 4. In the following embodiments, each of the operations may be performed sequentially, but they are not necessarily performed sequentially. For example, the order of each operation may be changed, and at least two operations may be performed in parallel. For example, the electronic device of FIG. 5 may be an electronic device 101 of FIG. 1, 2, or 3.

According to an embodiment with reference to FIG. 5, an electronic device (e.g., the electronic device 101) or a processor (e.g., the processor 120 of FIG. 1 or FIG. 2 or the processor 300 of FIG. 3) may, when connected to a network, periodically or continuously identify at least one of a channel state or a channel change rate with a network in operation 501.

According to an embodiment, an electronic device (e.g., the electronic device 101) or a processor (e.g., the processor 120 or 300) may identify whether the channel state with the network satisfies a designated channel state condition in operation 503. For example, the processor 300 may identify whether the most recently identified channel state with the network or an average value of the channel state with the network identified during a designated third time period satisfies a designated channel state condition. In an example, a state satisfying the designated channel state condition may include a state (e.g., medium electric field and/or strong electric field) in which the most recently identified channel state with the network or an average value of the channel states with the network identified during a designated third time period is equal to or greater than a value of a designated reference channel state. In an example, a state that does not satisfy the designated channel condition may include a state (e.g., weak electric field and/or strong field) in which the channel state with the most recently identified network or an average value of the channel state with the network identified during the designated third time period is smaller than a value of the designated reference channel state.

According to an embodiment, when it is determined that the channel state with the network satisfies the designated channel state condition (e.g., “yes” in operation 503), an electronic device (e.g., the electronic device 101) or a processor (e.g., the processor 120 or 300) may identify whether a channel change rate with the network satisfies a designated channel change condition in operation 505. For example, the processor 300 may identify whether the channel change rate with the network measured periodically or continuously during a designated first time period satisfies a designated channel change condition. In an example, a state satisfying the designated channel change condition may include a state in which the channel change rate with the network measured periodically or continuously during a designated first time period is lower than a designated reference change rate. In an example, a state that does not satisfy the designated channel change condition may include a state in which the channel change rate with the network measured periodically or continuously during the designated first time period is equal to or higher than the designated reference change rate.

According to an embodiment, in case that the channel change rate with the network satisfies the designated channel change condition (e.g., “yes” in operation 505), an electronic device (e.g., the electronic device 101) or a processor (e.g., the processor 120 or 300) may identify whether a power mode configuration variable exceeds a designated first threshold value in operation 507. In an example, the power mode configuration variable may include an accumulation value (or sum) of variables for controlling transmission power included in a designated number of signals for increasing or decreasing transmission power received at a time prior to the current timepoint among power control signals received from the network.

According to an embodiment, in case that the power mode configuration variable exceeds a designated first reference value (e.g., “yes” in operation 507), the electronic device (e.g., electronic device 101) or the processor (e.g., the processor 120 or 300) may determine that a designated first update condition associated with the transmission power control variable is satisfied, in operation 509. For example, the processor 300 may determine that the designated first update condition associated with the transmission power control variable is satisfied in case that the channel state with the network satisfies a designated channel state condition, the channel change rate with the network satisfies a designated channel change condition, and the power mode configuration variable exceeds a designated first reference value.

According to an embodiment, in case that the electronic device 101 determines that a designated first update condition associated with the transmission power control variable is satisfied, the transmission power of the electronic device 101 may be configured (or determined) based on a transmission power control variable (e.g., a second transmission power control variable) that is selectively updated based on a power control signal received from a network (or a network device).

According to an embodiment, in case that the channel state with the network does not satisfy a designated channel condition (e.g., “no” in operation 503), that the channel change rate with the network does not satisfy a designated channel change condition (e.g., “no” in operation 505), or that the power mode configuration variable is equal to or less than the designated first reference value (e.g., “no” in operation 507,), an electronic device (e.g., the electronic device 101) or a processor (e.g., the processor 120 or 300) may determine that the designated first update condition associated with the transmission power control variable is not satisfied, in operation 511.

According to an embodiment, in case that the electronic device 101 determines that the designated first update condition associated with the transmission power control variable is not satisfied, the transmission power of the electronic device 101 may be configured (or determined) based on the transmission power control variable (e.g., the first transmission power control variable) that is updated based on the power control signal received from the network (or the network device).

According to an embodiment, in order to identify whether the designated first update condition associated with the transmission power control variable is satisfied, the electronic device 101 may identify whether the channel state with the network satisfies a designated channel state condition (e.g., operation 503 of FIG. 5), identify whether the channel change rate with the network satisfies a designated channel change condition (e.g., operation 505 of FIG. 5), and identify whether the power mode configuration variable exceeds a designated first reference value (e.g., operation 507 of FIG. 5). However, the sequence of operations for identifying whether the designated first update condition associated with the transmission power control variable is satisfied, that is, identifying whether the channel state with the network satisfies a designated channel state condition (e.g., operation 503 of FIG. 5), identifying whether the channel change rate with the network satisfies a designated channel change condition (e.g., operation 505 of FIG. 5), and identifying whether the power mode configuration variable exceeds a designated first reference value (e.g., operation 507 of FIG. 5) may be varied or performed in parallel.

According to an embodiment, the electronic device 101 may identify that the designated first update condition associated with the transmission power control variable is satisfied based on at least one of the channel state with the network, the channel change rate with the network, or the power mode configuration variable.

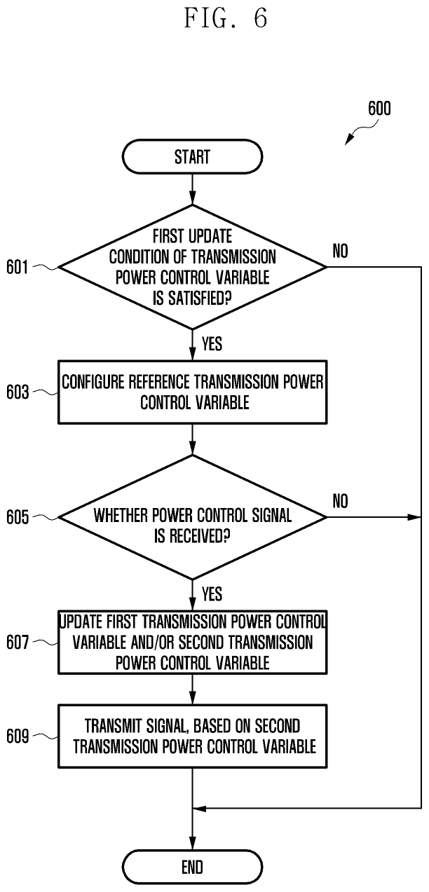

FIG. 6 is a flowchart 600 illustrating example operations for updating of a transmission power control variable while a designated first update condition associated with a transmission power control variable is satisfied, in an electronic device according to various embodiments. In an example, at least a portion of the operations of FIG. 6 may include the detailed operations of operations 405 to 409 of FIG. 4. In the following embodiments, each of the operations may be performed sequentially, but they are not necessarily performed sequentially. For example, the order of each operation may be changed, and at least two operations may be performed in parallel. For example, the electronic device of FIG. 6 may correspond to the electronic device 101 of FIG. 1, 2 or 3.

According to an embodiment with reference to FIG. 6, an electronic device (e.g., the electronic device 101) or a processor (e.g., the processor 120 of FIG. 1 or FIG. 2 or the processor 300 of FIG. 3) may, when connected to a network, identify whether a designated first update condition associated with a transmission power control variable is satisfied while being connected to the network, in operation 601. For example, the processor 300 may identify that the designated first update condition associated with the transmission power control variable is satisfied, based on operations 501 to 511 of FIG. 5.

For example, the processor 300 may identify that the designated first update condition associated with the transmission power control variable is satisfied, based on at least one of the channel state with the network, the channel change rate with the network, or the power mode configuration variable.

For example, the processor 300 may determine that the designated first update condition associated with the transmission power control variable is satisfied in case that the channel state with the network satisfies the designated channel state condition, the channel change rate with the network satisfies the designated channel change condition, and the power mode configuration variable exceeds the designated first reference value.

For example, the processor 300 may determine that the designated first update condition associated with the transmission power control variable is not satisfied in case that the channel state with the network does not satisfy the designated channel state condition, the channel change rate with the network does not satisfy the designated channel change condition, or the power mode configuration variable is equal to or smaller than the designated first reference value.

According to an embodiment, when it is determined that the designated first update condition associated with the transmission power control variable is not satisfied (e.g., “no” in operation 601), an electronic device (e.g., the electronic device 101) or a processor (e.g., the processor 120 or 300) may end controlling the transmission power while the designated first update condition associated with the transmission power control variable is satisfied. For example, when it is determined that the designated first update condition associated with the transmission power control variable is not satisfied, the processor 300 may configure (or update) the transmission power of the electronic device 101, based on a first transmission power control variable configured (or updated) based on the power control signal. For example, when it is determined that the designated first update condition associated with the transmission power control variable is not satisfied, the processor 300 may continuously or periodically identify whether the designated first update condition associated with the transmission power control variable is satisfied while maintaining a connection with the network.

In an embodiment, when it is determined that the designated first update condition associated with the transmission power control variable is satisfied (e.g., “yes” in operation 601), an electronic device (e.g., the electronic device 101) or a processor (e.g., the processor 120 or 300) may configure a reference transmission power control variable in operation 603. For example, the processor 300 may configure, as the reference transmission power control variable, an average value of the first transmission power control variables that has been identified for a designated second time period prior to a timepoint at which the designated first update condition associated with the transmission power control variable is determined as having been satisfied.

According to an embodiment, an electronic device (e.g., the electronic device 101) or a processor (e.g., the processor 120 or 300) may identify whether a power control signal (e.g., a TPC command) is received from the network, in operation 605.

According to an embodiment, in case that the power control signal is received from the network (e.g., “yes” in operation 605), an electronic device (e.g., the electronic device 101) or a processor (e.g., the processor 120 or 300) may update a first transmission power control variable and/or a second transmission power control variable, based on the power control signal, in operation 607. For example, when it is determined that a designated first update condition associated with the transmission power control variable is satisfied, the processor 300 may identify that there is a second transmission power control variable that operates independently of the first transmission power control variable. For example, when it is determined that there is no second transmission power control variable, the processor 300 may generate a second transmission power control variable corresponding to the first transmission power control variable to configure the transmission power of the electronic device 101. In an example, the second transmission power control variable may include the same value as the first transmission power control variable as its initial value. For example, an operation of generating a second transmission power control variable may be skipped when the processor 300 determines that a second transmission power control variable exists.

For example, in case that the power control signal is received from the network via the communication circuit 310, the processor 300 may update the first transmission power control variable and/or the second transmission power control variable, based on the power control signal. In an example, the first transmission power control variable may be decreased, maintained, or increased based on a variable (e.g., −1, 0, 1, or 3) for controlling the transmission power included in the power control signal. In an example, in case that a designated first update condition associated with the transmission power control variable is satisfied, the second transmission power control variable may be decreased or maintained based on a variable (e.g., −1, 0, 1, or 3) for controlling the transmission power included in the power control signal, and an increase of which may be restricted based on a variable (e.g., −1, 0, 1, or 3) for controlling the transmission power included in the power control signal.

For example, in case that the second transmission power control variable updated (e.g., maintained or decreased) based on the power control signal is smaller than the reference transmission power control variable, the processor 300 may additionally update the second transmission power control variable, based on the reference transmission power control variable. In an example, the second transmission power control variable may additionally be updated to the same value as the reference transmission power control variable.

For example, in case that a difference value between the first transmission power control variable updated based on the power control signal and the second transmission power control variable updated based on the power control signal and/or the reference transmission power control variable satisfies a designated second update condition associated with the transmission power control variable, the processor 300 may additionally update the second transmission power control variable, based on the first transmission power control variable and a designated third reference value. In an example, a state satisfying the designated second update condition associated with the transmission power control variable may include a state in which a difference value between the second transmission power control variable, which is updated based on the power control signal and/or the reference transmission power control variable, and the first transmission power control variable exceeds the designated third reference value. In an example, the second transmission power control variable may additionally be updated (or configured) to a value obtained by subtracting the designated third reference value from the first transmission power control variable.

According to an embodiment, an electronic device (e.g., the electronic device 101) or a processor (e.g., the processor 120 or 300) may transmit at least one signal (or data) to a network (or a network device), based on the second transmission power control variable, in operation 609. For example, the processor 300 may configure (or update) the transmission power of the electronic device 101, based on a second transmission power control variable that is selectively updated based on a power control signal obtained from the network. The processor 300 may control the communication circuit 310 to transmit at least one signal (or data) to the network (or the network device) with the transmission power configured (or updated) based on the second transmission power control variable. In an example, the transmission power of the electronic device 101 may include the power used by the electronic device 101 to transmit at least one of the signal or data to a network.

According to an embodiment, in case that a power control signal is not received from the network (e.g., “no” in operation 605), an electronic device (e.g., the electronic device 101) or a processor (e.g., the processor 120 or 300) may end controlling transmission power while a designated first update condition associated with a transmission power control variable is satisfied. For example, the processor 300 may continuously or periodically identify whether the power control signal is received from the network while being connected to the network. For example, in case that the power control signal is received from the network, the processor 300 may update the first transmission power control variable and/or the second transmission power control variable, based on the power control signal (e.g., operation 607).

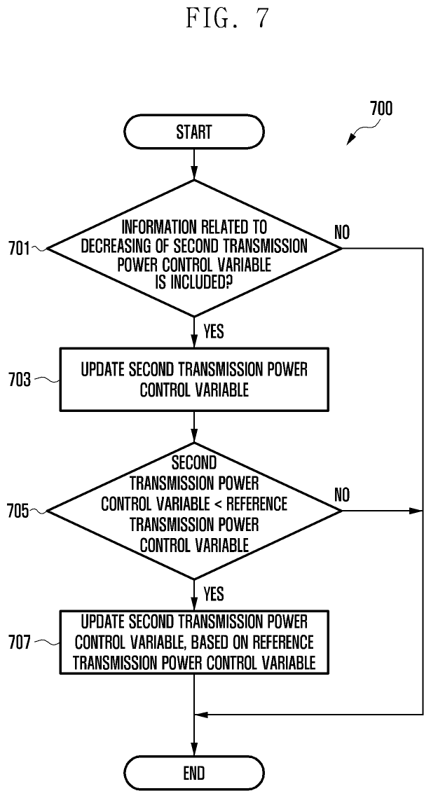

FIG. 7 is a flowchart 700 illustrating example operations for updating of a second transmission power control variable based on a power control signal in an electronic device according to various embodiments. In an example, at least a portion of operations of FIG. 7 may include the detailed operation of operation 407 of FIG. 4 or operation 607 of FIG. 6. In the following embodiments, each of the operations may be performed sequentially, but they are not necessarily performed sequentially. For example, the order of each operation may be changed, and at least two operations may be performed in parallel. In an example, the electronic device of FIG. 7 may be an electronic device 101 of FIG. 1, FIG. 2, or FIG. 3.

According to an embodiment with reference to FIG. 7, in case that a power control signal is received from a network (e.g., “yes” in operation 605 of FIG. 6), an electronic device (e.g., the electronic device 101) or a processor (e.g., the processor 120 of FIG. 1 or FIG. 2 or the processor 300 of FIG. 3) may identify whether to decrease a second transmission power control variable, based on the power control signal, in operation 701. For example, in case that the power control signal received from the network includes a variable (e.g., −1) for decreasing the transmission power of the electronic device 101, the processor 300 may determine to decrease the second transmission power control variable. For example, in case that the power control signal received from the network includes a variable (e.g., 0, 1, or 3) for maintaining or increasing the transmission power of the electronic device 101, the processor 300 may determine not to decrease the second transmission power control variable.

According to an embodiment, when it is determined not to decrease the second transmission power control variable, based on the power control signal (e.g., “no” in operation 701), an electronic device (e.g., the electronic device 101) or a processor (e.g., the processor 120 or 300) may end updating the second transmission power control variable. For example, the processor 300 may maintain a second transmission power control variable in case that the power control signal received from the network includes a variable (e.g., 0) for maintaining the transmission power of the electronic device 101. For example, the processor 300 may maintain the second transmission power control variable even in case that the power control signal received from the network includes a variable (e.g., 1, or 3) for increasing the transmission power of the electronic device 101).

According to an embodiment, when it is determined to decrease the second transmission power control variable based on the power control signal (e.g., “yes” in operation 701), an electronic device (e.g., the electronic device 101) or a processor (e.g., the processor 120 or 300) may update the second transmission power control variable in operation 703. For example, the processor 300 may decrease the second transmission power control variable by a designated value (e.g., −1), based on the power control signal.

According to an embodiment, an electronic device (e.g., the electronic device 101) or a processor (e.g., the processor 120 or 300) may identify whether the second transmission power control variable updated (e.g., decreased) based on the power control signal is less than the reference transmission power control variable, in operation 705.

According to an embodiment, in case that the second transmission power control variable updated (e.g., decreased) based on the power control signal is smaller than the reference transmission power control variable (e.g., “yes” in operation 705), an electronic device (e.g., the electronic device 101) or a processor (e.g., the processor 120 or 300) may update the second transmission power control variable, based on the reference transmission power control variable, in operation 707. For example, in case that the second transmission power control variable updated (e.g., maintained or decreased) based on the power control signal is smaller than the reference transmission power control variable, the processor 300 may update the second transmission power control variable to be the same value as the reference transmission power control variable.

According to an embodiment, in case that the second transmission power control variable updated (e.g., decreased) based on the power control signal is equal to or greater than the reference transmission power control variable (e.g., “no” in operation 705), an electronic device (e.g., the electronic device 101) or a processor (e.g., the processor 120 or 300) may end updating the second transmission power control variable.

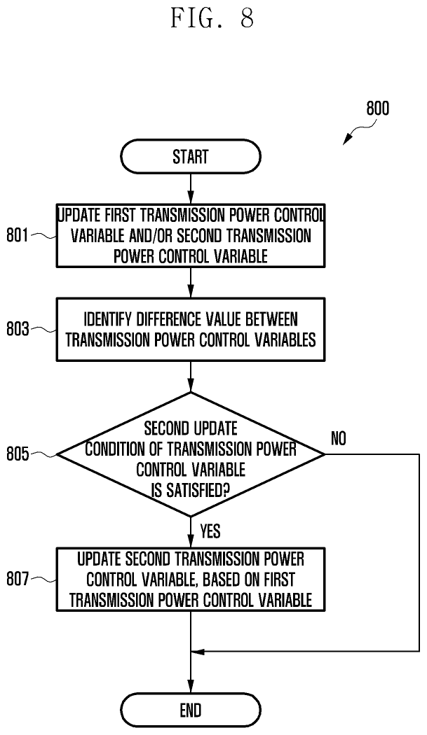

FIG. 8 is a flowchart 800 illustrating example operations for updating a second transmission power control variable, based on a first transmission power control variable in an electronic device according to various embodiments. In an example, at least a portion of operations of FIG. 8 may include the detailed operation of operation 407 of FIG. 4 or operation 607 of FIG. 6. In the following embodiments, each of the operations may be performed sequentially, but they are not necessarily performed sequentially. For example, the order of each operation may be changed, and at least two operations may be performed in parallel. For example, the electronic device of FIG. 8 may be the electronic device 101 of FIG. 1, 2, or 3.

According to an embodiment with reference to FIG. 8, in case that a power control signal is received from a network (e.g., “yes” in operation 605 of FIG. 6), an electronic device (e.g., the electronic device 101) or a processor (e.g., the processor 120 of FIG. 1 or FIG. 2 or the processor 300 of FIG. 3) may update a first transmission power control variable and/or a second transmission power control variable, based on the power control signal, in operation 801. For example, the processor 300 may update the first transmission power control variable, based on the power control signal received from the network. In an example, the first transmission power control variable may be decreased in case that the power control signal received from the network includes a variable (e.g., −1) for decreasing the transmission power of the electronic device 101. In an example, the first transmission power control variable may be maintained in case that the power control signal received from the network includes a variable (e.g., 0) for maintaining the transmission power of the electronic device 101. In an example, the first transmission power control variable may be increased in case that the power control signal received from the network includes a variable (e.g., 1, or 3) for increasing the transmission power of the electronic device 101.

For example, in case that a designated first update condition associated with the transmission power control variable is satisfied, the processor 300 may selectively update a second transmission power control variable, based on a power control signal received from the network. In an example, the second transmission power control variable may be decreased in case that the power control signal received from the network includes a variable (e.g., −1) for decreasing the transmission power of the electronic device 101 while the designated first update condition associated with the transmission power control variable is satisfied. In an example, the second transmission power control variable may be maintained in case that the power control signal received from the network includes a variable (e.g., 0) for maintaining the transmission power of the electronic device 101 while the designated first update condition associated with the transmission power control variable is satisfied. In an example, the second transmission power control variable may be maintained in case that the power control signal received from the network includes a variable (e.g., 1 or 3) for increasing the transmission power of the electronic device 101 while the designated first update condition associated with the transmission power control variable is satisfied. In an example, the increase of the second transmission power control variable may be restricted based on a power control signal received from the network while a designated first update condition associated with the transmission power control variable is satisfied.

For example, in case that the second transmission power control variable updated (e.g., maintained or decreased) based on the power control signal is smaller than the reference transmission power control variable, the processor 300 may additionally update the second transmission power control variable to be the same value as the reference transmission power control variable.

According to an embodiment, an electronic device (e.g., the electronic device 101) or a processor (e.g., the processor 120 or 300) may identify a difference value between a first transmission power control variable updated based on a power control signal and a second transmission power control variable updated based on a power control signal and/or a reference transmission power control variable, in operation 803.

According to an embodiment, an electronic device (e.g., the electronic device 101) or a processor (e.g., the processor 120 or 300) may identify whether a difference value between the first transmission power control variable and the second transmission power control variable satisfies a designated second update condition associated with a transmission power control variable, in operation 805. For example, in case that the difference value between the first transmission power control variable and the second transmission power control variable exceeds a designated third reference value, the processor 300 may determine that the designated second update condition associated with the transmission power control variable is satisfied. For example, in case that the difference value between the first transmission power control variable and the second transmission power control variable is equal to or smaller than a designated third reference value, the processor 300 may determine that the designated second update condition associated with the transmission power control variable is not satisfied.

In an embodiment, when it is determined that the difference value between the first transmission power control variable and the second transmission power control variable does not satisfy the designated second update condition associated with the transmission power control variable (e.g., “no” in operation 805), an electronic device (e.g., the electronic device 101) or a processor (e.g., the processor 120 or 300) may end updating the second transmission power control variable. For example, the processor 300 may maintain the second transmission power control variable updated based on a power control signal and/or a reference transmission power control variable.

According to an embodiment, when it is determined that the difference value between the first transmission power control variable and the second transmission power control variable satisfies the designated second update condition associated with the transmission power control variable (e.g., “yes” in operation 805), an electronic device (e.g., the electronic device 101) or a processor (e.g., the processor 120 or 300) may additionally update the second transmission power control variable, based on the first transmission power control variable, in operation 807. For example, in case that the difference value between the first transmission power control variable updated based on the power control signal and the second transmission power control variable updated based on the power control signal and/or the reference transmission power control variable exceeds a designated third reference value, the processor 300 may additionally update the second transmission power control variable, based on the first transmission power control variable and the designated third reference value. In an example, the second transmission power control variable may additionally be updated (or configured) to a value obtained by subtracting the designated third reference value from the first transmission power control variable.

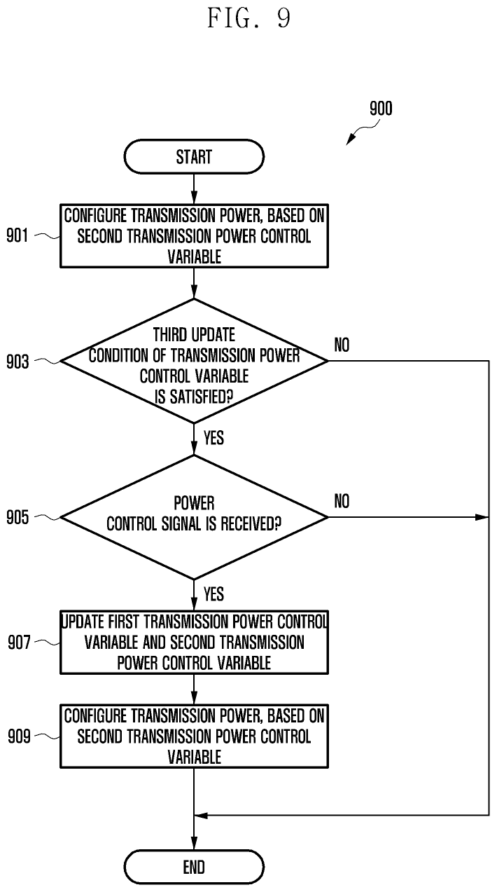

FIG. 9 is a flowchart 900 illustrating example operations for updating of a transmission power control variable while a designated third update condition associated with a transmission power control variable is satisfied, in an electronic device according to various embodiments. In the following embodiments, each of operations may be performed sequentially, but they are not necessarily performed sequentially. For example, the order of each operation may be changed, and at least two operations may be performed in parallel. For example, the electronic device of FIG. 9 may be an electronic device 101 of FIG. 1, 2 or 3.

According to an embodiment with reference to FIG. 9, an electronic device (e.g., the electronic device 101) or a processor (e.g., the processor 120 of FIG. 1 or FIG. 2 or the processor 300 of FIG. 3) may configure the transmission power of the electronic device 101, based on a second transmission power control variable while a designated first update condition associated with a transmission power control variable is satisfied, in operation 901. For example, when there is at least one signal (or data) to be transmitted to a network (or a network device), the processor 300 may control the communication circuit 310 to transmit the at least one signal (or data) to the network (or the network device) with the transmission power configured (or updated) based on the second transmission power control variable.

According to an embodiment, an electronic device (e.g., the electronic device 101) or a processor (e.g., the processor 120 or 300) may identify whether a designated third update condition associated with the transmission power control variable is satisfied, in operation 903. For example, the processor 300 may continuously or periodically identify at least one of a channel state or a channel change rate with the network while being connected to the network. For example, in case that the channel state with the network does not satisfy a designated channel state condition, the processor 300 may determine that a designated third update condition associated with the transmission power control variable is satisfied. For example, in case that the channel change rate with the network does not satisfy a designated channel change condition, the processor 300 may determine that a designated third update condition associated with the transmission power control variable is satisfied. For example, the processor 300 may determine that the designated third update condition associated with the transmission power control variable is satisfied in case that a power mode configuration variable is equal to or smaller than a designated second reference value.

For example, in case that the channel state with the network satisfies the designated channel state condition, the channel change rate with the network satisfies the designated channel change condition, and the power mode configuration variable exceeds the designated second reference value, the processor 300 may determine that the designated third update condition associated with the transmission power control variable is not satisfied.

According to an embodiment, when it is determined that the designated third update condition associated with the transmission power control variable is not satisfied (e.g., “no” in operation 903), an electronic device (e.g., the electronic device 101) or a processor (e.g., the processor 120 or 300) may end updating a transmission power control variable while a designated third update condition associated with the transmission power control variable is satisfied. For example, when it is determined that the designated third update condition associated with the transmission power control variable is not satisfied, the processor 300 may configure (or update) the transmission power of the electronic device 101, based on a second transmission power control variable that is selectively updated based on a power control signal received from the network. For example, in case that a connection to the network is maintained while the designated first update condition associated with the transmission power control variable is satisfied, the processor 300 may continuously or periodically identify whether the designated third update condition associated with the transmission power control variable is satisfied.

According to an embodiment, when it is determined that the designated third update condition associated with the transmission power control variable is satisfied (e.g., “yes” in operation 903), an electronic device (e.g., the electronic device 101) or a processor (e.g., the processor 120 or 300) may identify whether a power control signal is received from the network in operation 905.

According to an embodiment, in case that the power control signal is received from the network (e.g., “yes” in operation 905), an electronic device (e.g., the electronic device 101) or a processor (e.g., the processor 120 or 300) may update the first transmission power control variable and the second transmission power control variable, based on the power control signal, in operation 907.

For example, in case that the power control signal is received from the network via the communication circuit 310, the processor 300 may update the first transmission power control variable and the second transmission power control variable, based on the power control signal. In example, the first transmission power control variable may be decreased, maintained, or increased based on a variable (e.g., −1, 0, 1, or 3) for controlling the transmission power included in the power control signal. In an example, in case that a designated third update condition associated with the transmission power control variable is satisfied, the second transmission power control variable may be decreased, maintained, or increased based on a variable (e.g., −1, 0, 1, or 3) for controlling the transmission power included in the power control signal.

For example, in case that the second transmission power control variable updated based on the power control signal is less than a minimum transmission power control variable, the processor 300 may update the second transmission power control variable to the same value as the minimum transmission power control variable. In an example, the minimum transmission power control variable may include a minimum value of the transmission power control variable enabling the electronic device 101 to maintain a connection to the network.

According to an embodiment, an electronic device (e.g., the electronic device 101) or a processor (e.g., the processor 120 or 300) may configure (or update) the transmission power of the electronic device 101, based on the second transmission power control variable, in operation 909. In an example, the transmission power of the electronic device 101 may be used to transmit at least one of a signal or data by the electronic device 101 to the network. For example, when there is at least one signal (or data) to be transmitted to the network (or a network device), the processor 300 may control the communication circuit 310 to transmit at least one signal (or data) to the network (or the network device) with the transmission power configured (or updated) based on the second transmission power control variable.

According to an embodiment, in case that a power control signal is not received from the network (e.g., “no” in operation 905), an electronic device (e.g., the electronic device 101) or a processor (e.g., the processor 120 or 300) may end updating the transmission power control variable while a designated third update condition associated with the transmission power control variable is satisfied. For example, the processor 300 may continuously or periodically identify whether the power control signal is received from the network while being connected to the network. For example, in case that the power control signal is received from the network, the processor 300 may update the first transmission power control variable and the second transmission power control variable, based on the power control signal (e.g., operation 907).

According to an embodiment, the electronic device 101 may dynamically configure reference values associated with the designated third update condition associated with the transmission power control variable, based on the channel state with the network. For example, the reference values associated with the designated third update condition associated with the transmission power control variable may include at least one of a designated number of signals for configuring the power mode configuration variable, a designated second reference value for determining the designated third update condition associated with the transmission power control variable, or a designated third reference value for determining whether to update the second transmission power control variable.

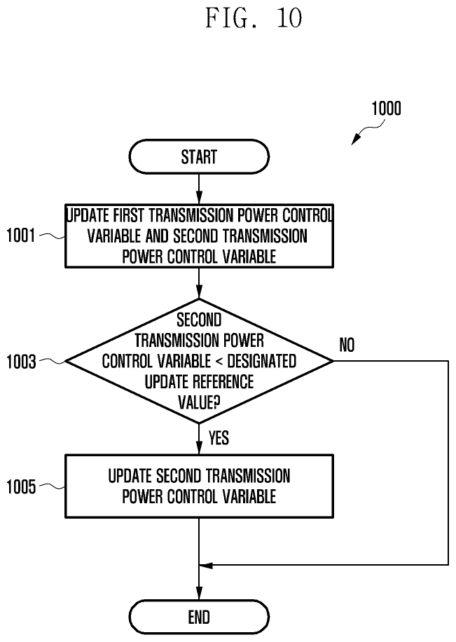

FIG. 10 is a flowchart 1000 illustrating example operations for updating a second transmission power control variable while a designated third update condition associated with a transmission power control variable is satisfied, in an electronic device according to various embodiments. For example, at least a portion of operations of FIG. 10 may include the detailed operation of operation 907 of FIG. 9.

In the following embodiments, each of the operations may be performed sequentially, but they are not necessarily performed sequentially. For example, the order of each operation may be changed, and at least two operations may be performed in parallel. For example, the electronic device of FIG. 10 may be the electronic device 101 of FIG. 1, 2, or 3.

According to an embodiment with reference to FIG. 10, in case that a power control signal is received from a network while a designated third update condition associated with a transmission power control variable is satisfied (e.g., “yes” in operation 905 of FIG. 9), an electronic device (e.g., the electronic device 101) or a processor (e.g., the processor 120 of FIG. 1 or FIG. 2 or the processor 300 of FIG. 3) may update a first transmission power control variable and a second transmission power control variable, based on the power control signal, in operation 1001. For example, in case that the power control signal is received from the network via the communication circuit 310, the processor 300 may update the first transmission power control variable and the second transmission power control variable, based on the power control signal. In an example, the first transmission power control variable may be decreased, maintained, or increased based on a variable (e.g., −1, 0, 1, or 3) for controlling the transmission power included in the power control signal. In an example, in case that a designated third update condition associated with the transmission power control variable is satisfied, the second transmission power control variable may be decreased, maintained, or increased based on a variable (e.g., −1, 0, 1, or 3) for controlling the transmission power included in the power control signal.

According to an embodiment, an electronic device (e.g., the electronic device 101) or a processor (e.g., the processor 120 or 300) may identify whether the second transmission power control variable updated based on the power control signal is less than a designated update reference value in operation 1003. In an example, the designated update reference value may include a minimum value of the transmission power control variable (e.g., a minimum transmission power control variable) enabling the electronic device 101 to maintain a connection to the network.

According to an embodiment, in case that the second transmission power control variable updated based on the power control signal is equal to or greater than a designated update reference value (e.g., “no” in operation 1003), an electronic device (e.g., the electronic device 101) or a processor (e.g., the processor 120 or 300) may end updating the second transmission power control variable while the designated third update condition associated with the transmission power control variable is satisfied. For example, the processor 300 may maintain the second transmission power control variable that is updated based on the power control signal.

According to an embodiment, in case that the second transmission power control variable updated based on the power control signal is smaller than a designated update reference value (e.g., “yes” in operation 1003), an electronic device (e.g., the electronic device 101) or a processor (e.g., the processor 120 or 300) may update the second transmission power control variable, based on the designated update reference value, in operation 1005. For example, in case that the second transmission power control variable updated based on the power control signal is smaller than the designated reference value (e.g., the minimum transmission power control variable), the processor 300 may update the second transmission power control variable to the designated reference value.

According to an embodiment, when it is determined that a designated first update condition associated with a transmission power control variable is satisfied while a designated third update condition associated with the transmission power control variable is satisfied, the electronic device 101 may configure (or update) the transmission power of the electronic device 101, based on the transmission power control variable (e.g., the second transmission power control variable) that is selectively updated based on the power control signal received from the network. For example, the processor 300 may configure (or update) the transmission power of the electronic device 101, based on operations 601 to 609 of FIG. 6.

According to an embodiment, in case that the second transmission power control variable exists in a state of being connected to a network, the electronic device 101 may configure (or update) the transmission power of the electronic device 101, based on the second transmission power control variable while the connection between the electronic device 101 and the network is maintained. For example, the state in which the connection between the electronic device 101 and the network is maintained may include at least one of a state in which an RRC state with the network is maintained as an RRC connected state or a state in which a PUSCH configuration by the network is maintained.

According to an example embodiment, a method for operating an electronic device (e.g., the electronic device 101 of FIG. 1, 2, or 3) may include: configuring a transmission power control variable, based on a transmission power control (TPC) signal received from a network to which the electronic device is connected; based on a designated first update condition being satisfied while electronic device is connected to the network, restricting an increase of the transmission power control variable based on a TPC signal indicating an increase of the transmission power control variable from the network; and transmitting at least one signal with transmission power based on the transmission power control variable, the increase of which is restricted based on the TPC signal.

According to an example embodiment, the method for operating an electronic device may include: based on the designated first update condition being satisfied while the electronic device is connected to the network, configuring a second transmission power control variable corresponding to a first transmission power control variable configured based on the TPC signal received from the network, wherein the increase of the second transmission power control variable is restricted based on the TPC signal in a state in which the designated first update condition is satisfied.

According to an example embodiment, the method for operating an electronic device may include identifying whether the designated first update condition is satisfied, based on at least one of a channel state with the network, a channel change rate with the network, or a power mode configuration variable while being connected to the network.

According to an example embodiment, the power mode configuration variable may include an accumulation value of a designated number of TPC signals indicating an increase or decrease of the first transmission power control variable.

According to an example embodiment, the method for operating an electronic device may include, based on the designated first update condition is satisfied, configuring a reference transmission power control variable, based on an average value of the first transmission power control variables configured based on the designated number of TPC signals.

According to an example embodiment, the configuring of the second transmission power control variable may include decreasing the second transmission power control variable, based on the power control signal received from the network. According to an example embodiment, the configuring of the second transmission power control variable may include based on the second transmission power control variable being decreased based on the TPC signal being less than the reference transmission power control variable, updating the second transmission power control variable, based on the reference transmission power control variable.

According to an example embodiment, the method for operating an electronic device may include based on the TPC signal received from the network including a variable associated with decreasing the transmission power of the electronic device, decreasing the second transmission power control variable by a designated magnitude. According to an example embodiment, the method for operating an electronic device may include based on the TPC signal received from the network including a variable associated with maintaining or increasing the transmission power of the electronic device, restricting update of the second transmission power control variable.

According to an example embodiment, the method for operating an electronic device may include based on a second transmission power control variable being selectively updated based on a TPC signal, increasing, maintaining, or decreasing a first transmission power control variable based on the TPC signal.

According to an example embodiment, the method of operation of the electronic device may include based on a difference value between the first transmission power control variable and the second transmission power control variable satisfying a designated second update condition, updating the second transmission power control variable, based on the first transmission power control variable.

According to an example embodiment, the method for operating an electronic device may include based on a designated third update condition different from a designated first update condition being satisfied while the designated first update condition is determined as having been satisfied, configuring a transmission power control variable, based on a TPC signal received from the network. According to an example embodiment, the transmission power control variable may be increased, maintained, or decreased based on the TPC signal while the designated third update condition is satisfied.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
communication circuitry;
at least one processor including processing circuitry; and
memory storing instructions, wherein the instructions, when executed by at least one processor, individually or collectively, cause the electronic device to:
determine a transmission power control variable based on a transmission power control (TPC) signal received from a network to which the electronic device is connected using the communication circuitry,
based on a specified first update condition being satisfied while the electronic device is connected to the network, restrict an increase of the transmission power control variable based on a TPC signal indicating an increase of the transmission power control variable from the network, and
transmit at least one signal with transmission power based on the transmission power control variable, the increase of which is restricted.

2. The electronic device of claim 1, where the memory storing instructions, when executed by at least one processor, individually or collectively, cause the electronic device to,
based on the specified first update condition being satisfied while the electronic device is connected to the network, determine a second transmission power control variable corresponding to a first transmission power control variable determined based on the TPC signal received from the network,
wherein the second transmission power control variable restricts an increase of the transmission power control variable based on the TPC signal received from the network in a state in which the specified first update condition is satisfied.

3. The electronic device of claim 2, wherein the memory storing instructions, when executed by at least one processor, individually or collectively, cause the electronic device to, determine whether the specified first update condition is satisfied based on at least one of a channel state with the network, a channel change rate with the network or a power mode configuration variable while the electronic device is connected to the network.

4. The electronic device of claim 3, wherein the power mode configuration variable comprises an accumulation value of a designated number of TPC signals indicating an increase or decrease of the first transmission power control variable.

5. The electronic device of claim 4, wherein the memory storing instructions, when executed by at least one processor, individually or collectively, cause the electronic device to:
based on the specified first update condition being satisfied, determine a reference transmission power control variable based on an average value of the first transmission power control variables configured based on the designated number of TPC signals; and
based on the second transmission power control variable decreased based on the TPC signal being less than the reference transmission power control variable, update the second transmission power control variable based on the reference transmission power control variable.

6. The electronic device of claim 2, wherein the memory storing instructions, when executed by at least one processor, individually or collectively, cause the electronic device to:
based on the TPC signal from received from the network including a variable related to decreasing the transmission power of the electronic devices, decrease the second transmission power control variable by a specified amount, or
based on the TPC signal from received from the network including a variable related to maintaining or increasing the transmission power of the electronic devices, restrict update of the second transmission power control variable.

7. The electronic device of claim 6, wherein the memory storing instructions, when executed by at least one processor, individually or collectively, cause the electronic device to, based on the second transmission power control variable being selectively updated based on the TPC signal, decrease, maintain or increase the first transmission power control variable based on the TPC signal.

8. The electronic device of claim 7, wherein the memory storing instructions, when executed by at least one processor, individually or collectively, cause the electronic device to, based on a difference value between the first transmission power control variable and the second transmission power control variable is satisfied a predetermined second update condition different from the predetermined the first update condition, update the second transmission power control variable based on the first transmission power control variable.

9. The electronic device of claim 1, wherein the memory storing instructions, when executed by at least one processor, individually or collectively, cause the electronic device to:
based on a specified third update condition different from the specified first update condition being satisfied while the specified first update condition is determined to be satisfied, determine the transmission power control variable based on the TPC signal received from the network using the communication circuitry, and
wherein the transmission power control variable is increased, maintained or decreased based on TPC signal received from the network while the predetermined third update condition is satisfied.

10. A method for operating an electronic device, the method comprising:
configuring a transmission power control variable, based on a transmission power control (TPC) signal received from a network to which the electronic device is connected;
based on a designated first update condition being satisfied while the electronic device is connected to the network, restricting an increase of the transmission power control variable based on a TPC signal indicating an increase of the transmission power control variable from the network; and
transmitting at least one signal with transmission power based on the transmission power control variable, the increase of which is restricted.

11. The method of claim 10, further comprising, based on the designated first update condition being satisfied while the electronic device is connected to the network, configuring a second transmission power control variable corresponding to a first transmission power control variable configured based on the TPC signal received from the network,
wherein the increase of the second transmission power control variable is restricted based on the TPC signal in a state in which the designated first update condition is satisfied.

12. The method of claim 10, further comprising identifying whether the designated first update condition is satisfied, based on at least one of a channel state with the network, a channel change rate with the network, or a power mode configuration variable while the electronic device is connected to the network.

13. The method of claim 12, wherein the power mode configuration variable comprises an accumulation value of a designated number of TPC signals indicating an increase or decrease of the first transmission power control variable.

14. The method of claim 13, further comprising, based on the designated first update condition being satisfied, configuring a reference transmission power control variable, based on an average value of the first transmission power control variables configured based on the designated number of TPC signals,
wherein the configuring of the second transmission power control variable comprises:
decreasing the second transmission power control variable, based on the TPC signal received from the network; and
based on the second transmission power control variable decreased based on the TPC signal being less than the reference transmission power control variable, updating the second transmission power control variable, based on the reference transmission power control variable.

15. The method of claim 11, further comprising:
based on the TPC signal received from the network including a variable associated with decreasing the transmission power of the electronic device, decreasing the second transmission power control variable by a designated magnitude; or
based on the TPC signal received from the network including a variable associated with maintaining or increasing the transmission power of the electronic device, restricting update of the second transmission power control variable.

16. The method of claim 15, further comprising,
based on a second transmission power control variable being selectively updated based on a TPC signal, increasing, maintaining, or decreasing the first transmission power control variable based on the TPC signal.

17. The method of claim 16, further comprising,
based on a difference value between the first transmission power control variable and the second transmission power control variable is satisfied a designated second update condition different from the designated first update condition, updating the second transmission power control variable based on the first transmission power control variable.

18. The method of claim 10, further comprising,
based on a designated third update condition different from the designated first update condition being satisfied while the designated first update condition is determined to be satisfied, configuring a transmission power control variable based on the TPC signal received from the network, and
wherein the transmission power control variable is increased, maintained, or decreased based on the TPC signal while the designated third update condition is satisfied.

19. A non-transitory computer-readable storage medium for storing one or more programs, the one or more programs including instructions which, when executed by at least one processor, comprising processing circuitry, of an electronic device, individually and/or collectively, cause the processor to perform operations comprising:
configuring a transmission power control variable, based on a transmission power control (TPC) signal received from a network to which the electronic device is connected,
based on a designated first update condition being satisfied while the electronic device is connected to the network, restricting an increase of the transmission power control variable based on a TPC signal indicating an increase of the transmission power control variable from the network; and
transmitting at least one signal with transmission power based on the transmission power control variable, the increase of which is restricted.
